(19) United States
(12) Patent Application Publication
(10) Pub. No.: US 2026/0011773 A1
(43) Pub. Date: Jan. 8, 2026

(54) ALL-SOLID-STATE RECHARGEABLE BATTERIES AND MANUFACTURING METHOD THEREOF

(71) Applicant: SAMSUNG SDI CO., LTD., Yongin-si, Gyeonggi-do (KR)

(72) Inventors: Jaemin KIM, Yongin-si, Gyeonggi-do (KR); Jaejun LEE, Yongin-si, Gyeonggi-do (KR); Eungyeong LEE, Yongin-si, Gyeonggi-do (KR); Gunwook LEE, Yongin-si, Gyeonggi-do (KR); Sieun LEE, Yongin-si, Gyeonggi-do (KR)

(73) Assignee: SAMSUNG SDI CO., LTD., Yongin-si, Gyeonggi-do (KR)

(21) Appl. No.: 18/880,474

(22) PCT Filed: Jan. 9, 2024
(86) PCT No.: PCT/KR2024/000420

§ 371 Date: Dec. 31, 2024

(30) Foreign Application Priority Data
Apr. 12, 2023 (KR) 10-2023-0048342

(51) Int. Cl. H01M 10/056; H01M 4/525; H01M 10/052; H01M 10/0585; H01M 50/42; H01M 50/434; H01M 50/446

(52) U.S. Cl. CPC H01M 10/056; H01M 4/525; H01M 10/052; H01M 10/0585; H01M 50/42; H01M 50/434; H01M 50/446; H01M 2300/0065; H01M 2300/0094

(57) ABSTRACT

Disclosed are an all-solid-state rechargeable battery, and a method of manufacturing the same, the all-solid-state rechargeable battery including a negative electrode, a positive electrode, and a solid electrolyte layer between the negative electrode and positive electrode, wherein the solid electrolyte layer includes a first solid electrolyte layer in contact with the negative electrode, and a second solid electrolyte layer in contact with the positive electrode, the first solid electrolyte layer includes a first solid electrolyte and a first binder, the second solid electrolyte layer includes a second solid electrolyte and a second binder, and a glass transition temperature of the first binder is higher than a glass transition temperature of the second binder.

### TECHNICAL FIELD

All-solid-state rechargeable batteries and methods of manufacturing the same are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire of the batteries in the event of collision, penetration, and the like. Accordingly, an all-solid-state rechargeable battery using a solid electrolyte instead of an electrolyte solution has been proposed. All-solid-state rechargeable batteries are batteries in which all materials are made of solid, and thus they are safe as there is no risk of electrolyte solution leaking and exploding, and have the advantage of being easy to manufacture thin batteries.

In order to increase the energy density and reduce the resistance of all-solid-state rechargeable batteries, it is essential to manufacture and apply a thin film-type solid electrolyte membrane. However, the current limited slurry solvent and binder technology has limitations in thinning highly reactive sulfide-based solid electrolytes.
[Patent Document 1] Korean Publication No. 10-2017-0051324
[Patent Document 2] Korean Publication No. 10-2015-0103041

### DISCLOSURE

Provided is an all-solid-state rechargeable battery that can control lithium dendrites formed on a negative electrode and enhances interfacial bonding between a negative electrode and a solid electrolyte layer, thereby realizing excellent electrochemical characteristics.

In an embodiment, an all-solid-state rechargeable battery includes a negative electrode, a positive electrode, and a solid electrolyte layer between the negative electrode and the positive electrode, wherein the solid electrolyte layer includes a first solid electrolyte layer in contact with the negative electrode, and a second solid electrolyte layer in contact with the positive electrode, the first solid electrolyte layer includes a first solid electrolyte and a first binder, the second solid electrolyte layer includes a second solid electrolyte and a second binder, and a glass transition temperature of the first binder is higher than a glass transition temperature of the second binder.

In another embodiment, a method of manufacturing an all-solid-state rechargeable battery includes preparing a negative electrode, coating a first composition including a first solid electrolyte and a first binder on the negative electrode to form a first solid electrolyte layer, coating a second composition including a second solid electrolyte and a second binder on a first solid electrolyte layer to form a second solid electrolyte layer, and then drying it, stacking a positive electrode on the second solid electrolyte layer, wherein a glass transition temperature of the first binder is higher than a glass transition temperature of the second binder.

The all-solid-state rechargeable battery according to an embodiment can suppress lithium dendrites formed between a negative electrode and a solid electrolyte layer during charge and discharge, and improve interfacial adhesion between a positive electrode and a solid electrolyte layer, thereby improving overall performance such as initial charge and discharge capacity, rate capability, and cycle-life characteristics.

### DESCRIPTION OF THE DRAWINGS

FIGS. 1 and 2 are cross-sectional views schematically showing all-solid-state rechargeable batteries according to embodiments.

FIG. 3 is a graph showing rate capability of the all-solid-state rechargeable battery cells of Example 1 and Comparative Examples 1 and 3.

### MODE FOR INVENTION

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, a laminate, a composite, a copolymer, an alloy, a blend, a reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Here, “or” is not to be construed as an exclusive meaning, for example, “A or B” is construed to include A, B, A+B, and the like.

“Metal” is interpreted as a concept including ordinary metals, transition metals and metalloids (semi-metals).

All-solid-state Rechargeable Battery

In an embodiment, an all-solid-state rechargeable battery includes a negative electrode, a positive electrode, and a solid electrolyte layer between the negative electrode and the positive electrode, wherein the solid electrolyte layer includes a first solid electrolyte layer in contact with the negative electrode, and a second solid electrolyte layer in contact with the positive electrode, the first solid electrolyte layer includes a first solid electrolyte and a first binder, the second solid electrolyte layer includes a second solid electrolyte and a second binder, wherein a glass transition temperature of the first binder is higher than a glass transition temperature of the second binder.

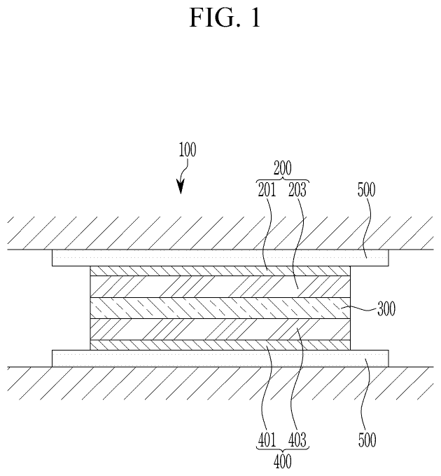

FIG. 1 is a cross-sectional view of an all-solid-state rechargeable battery according to an embodiment. Referring to FIG. 1, the all-solid-state rechargeable battery 100′ may have a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100′ may further include at least one elastic layer 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

### Solid Electrolyte Layer

In an all-solid-state rechargeable battery according to an embodiment, the solid electrolyte layer 300 has a multilayer structure. The multilayer structure may include two layers, three or more layers, or two or more layers and five or fewer layers. In the solid electrolyte layer, a portion in contact with the negative electrode is called the first solid electrolyte layer, and a portion in contact with the positive electrode is called the second solid electrolyte layer. The solid electrolyte layer may further include another layer between the first solid electrolyte layer and the second solid electrolyte layer.

The first solid electrolyte layer includes a first solid electrolyte and a first binder, and the second solid electrolyte layer includes a second solid electrolyte and a second binder. Here, a glass transition temperature (T_{g}) of the first binder is characterized as being higher than a glass transition temperature (T_{g}) of the second binder. The first solid electrolyte layer includes a first binder having high toughness, and the second solid electrolyte layer includes a second binder having high flexibility.

By designing the binder properties of the solid electrolyte layer in contact with the negative electrode and the solid electrolyte layer in contact with the positive electrode differently, the problems of the existing all-solid-state rechargeable battery can be solved. The first binder with relatively high T_{g} and high toughness may be applied to the first solid electrolyte layer in contact with the negative electrode to effectively suppress formation of lithium dendrite between the negative electrode and the first solid electrolyte layer during the charge and discharge and improve a binding force of the negative electrode to the first solid electrolyte layer. In addition, the second binder with relatively low T_{g} and high flexibility may be applied to the second solid electrolyte layer in contact with the positive electrode to improve bonding between the positive electrode and the second solid electrolyte layer and effectively suppress a volume change of the electrode plate according to the charge and discharge. Furthermore, the binders may be controlled from migration in the solid electrolyte layer, securing more uniform binder distribution. An all-solid-state rechargeable battery cell including such solid electrolyte layers may be improved in terms of overall electrochemical performance such as rate capability, cycle-life characteristics, and the like as well as in initial charge and discharge capacity.

Specifically, the glass transition temperature of the first binder may be, for example, 5° C. to 200° C. and specifically, 5° C. to 180° C., 6° C. to 160° C., 7° C. to 150° C., 8° C. to 130° C., or 9° C. to 120° C.

The glass transition temperature of the second binder may be −150° C. to 5° C., specifically −150° C. to 4° C., −150° C. to 3° C., −145° C. to 1° C., −140° C. to 0° C., −135° C. to −1° C., −130° C. to −5° C., or −125° C. to −10° C.

The glass transition temperature of the first binder may be higher by about 0.1° C. to 350° C. than that of the second binder, for example, by 1° C. to 300° C., 5° C. to 280° C., 10° C. to 260° C., 20° C. to 240° C., or 30° C. to 220° C. The first binder and the second binder are designed to have a T_{g} difference as aforementioned and thus improve overall electrochemical performance of an all-solid-state rechargeable battery.

Types of the first and second binders are not particularly limited but may be the same or different each other. If the first and second binders are the same type, they may have different T_{g} due to a difference in monomers or compositions, but if the first binder has higher T_{g} than the second binder, any binder may be applied.

For example, the first binder and the second binder may each independently include a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a chloroprene rubber, a natural rubber, polydimethylsiloxane, polyethyleneoxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene propylene copolymer, an ethylene propylene diene copolymer, polyamideimide, polyimide, poly(meth)acrylate, polyalkyl (meth)acrylate, polyacrylonitrile, polystyrene, polyurethane, or a combination thereof.

For example, the first binder may include polystyrene, polyurethane, polyimide, polyamideimide, poly(meth)acrylate, polyalkyl (meth)acrylate, polyacrylonitrile, or a combination thereof and for example polymethyl (meth)acrylate, polyethyl (meth)acrylate, polypropyl (meth)acrylate, polybutyl (meth)acrylate, polyacrylonitrile, or a combination thereof. The second binder may include an acrylic rubber, an acrylonitrile-butadiene rubber, a nitrile-butadiene rubber, a hydrogenated nitrile-butadiene rubber, a styrene-butadiene rubber, a butyl rubber, a fluorine rubber, a chloroprene rubber, a natural rubber, polydimethylsiloxane, or a combination thereof, and for example a nitrile-butadiene rubber, a chloroprene rubber, a natural rubber, polydimethylsiloxane, or a combination thereof.

The first binder may be included in an amount of 0.1 wt % to 5 wt %, based on 100 wt % of the first solid electrolyte layer, for example, 0.1 wt % to 3 wt % or 0.5 wt % to 2 wt %.

The second binder may be included in an amount of 0.1 wt % to 5 wt %, based on 100 wt % of the second solid electrolyte layer, for example, 0.1 wt % to 3 wt % or 0.5 wt % to 2 wt %.

The content of the first binder based on 100 wt % of the first solid electrolyte layer and the content of the second binder based on 100 wt % of the second solid electrolyte layer may be the same or different each other. For example, the content of the first binder based on 100 wt % of the first solid electrolyte layer may be larger than that of the second binder based on 100 wt % of the second solid electrolyte layer. For example, the content of the first binder based on 100 wt % of the first solid electrolyte layer may be 1.5 wt % to 5 wt %, and the content of the second binder based on 100 wt % of the second solid electrolyte layer may be 0.1 wt % to 1.0 wt %. In addition, the first binder and the second binder may have a weight ratio of 50:50 to 95:5, 50:50 to 80:20, or 60:40 to 90:10.

A thickness of the first solid electrolyte layer may be the same as or different from that of the second solid electrolyte layer. For example, the thickness of the first solid electrolyte layer may be substantially the same as that of the second solid electrolyte layer. The thickness of the first solid electrolyte layer may be 10 μm to 200 μm, for example, 10 μm to 150 μm, 10 μm to 100 μm, or 20 μm to 80 μm. The thickness of the second solid electrolyte layer may be 10 μm to 200 μm, for example, 10 μm to 150 μm, 10 μm to 100 μm, or 20 μm to 80 μm.

The solid electrolyte layer may be formed in a method described later, which includes coating the first composition including the first solid electrolyte and the first binder on a negative electrode or a substrate to form a first solid electrolyte layer, coating the second composition containing the second solid electrolyte and the second binder thereon to form a second solid electrolyte layer thereon, and then, drying them. According to this method and the like, between the first solid electrolyte and the second solid electrolyte layer, a third solid electrolyte layer, in which the first solid electrolyte, the second solid electrolyte, the first binder, and the second binder are mixed, may be formed. Furthermore, in the solid electrolyte layer, the first binder may exhibit a concentration gradient of decreasing from the negative electrode toward the positive electrode, and the second binder may exhibit a concentration gradient of decreasing from the positive electrode toward the negative electrode. The solid electrolyte layer, which have these two types of binder concentration gradients, exhibits high binder uniformity, high adhesion to each of the positive and negative electrodes and are advantageous in suppressing volume changes during the charge and discharge and formation of lithium dendrite, thereby improving overall electrochemical performance of an all-solid-state rechargeable battery. The first solid electrolyte and the second solid electrolyte may be the same or different. For example, the first solid electrolyte and the second solid electrolyte may have substantially the same composition and average particle size.

In an embodiment, the first solid electrolyte and the second solid electrolyte may be sulfide-based solid electrolytes having excellent ionic conductivity. The sulfide-based solid electrolyte particles may include for example Li₂S—P₂S₅, Li₂S—P₂S₅—LiX (wherein X is a halogen element, for example I, or CI), Li₂S—P₂S₅—Li₂O, Li₂S—P₂S₅—Li₂O—Lil, Li₂S—SiS₂, Li₂S—SiS₂—Lil, Li₂S—SiS₂—LiBr, Li₂S—SiS₂—LiCl, Li₂S—SiS₂—B₂S₃—Lil, Li₂S—SiS₂—P₂S₅—Lil, Li₂S—B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂—LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a molar ratio of 50:50 to 90:10 or 50:50 to 80:20 and optionally, performing heat treatment. Within the above mixing ratio range, a sulfide-based solid electrolyte having excellent ionic conductivity may be prepared. Here, other components such as SiS₂, GeS₂, and B₂S₃ may be added to further improve the ionic conductivity.

Mechanical milling or a solution method may be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a robust sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte may include an argyrodite-type sulfide. The argyrodite-type sulfide may be represented by a chemical formula of, for example, LiₐM_{b}P_{c}S_{d}Aₑ (wherein a, b, c, d, and e are all 0 or more and 12 or less, M is Ge, Sₙ, Si, or a combination thereof, and A is F, CI, Br, or I), and as a specific example, may be represented by a chemical formula of Li₇₋ₓPS₆₋ₓAₓ (wherein x is 0.2 or more and 1.8 or less, and A is F, Cl, Br, or I). The argyrodite-type sulfide may specifically be Li₃PS₄, Li₂P₃S₁₁, Li₂PS₆, Li₃PS₅Cl, Li₆PS₅Br, Li_{5.8}PS_{4.8}Cl_{1.2}, Li_{6.2}PS_{5.2}Br_{0.8}, and the like.

A sulfide-based solid electrolyte including such argyrodite-type sulfides may have a high ionic conductivity close to the ionic conductivity of a typical liquid electrolyte at room temperature, which is in the range of 10-4 to 10-2 S/cm, and may form a close bond between a positive electrode active material and a solid electrolyte without causing a decrease in ionic conductivity, and further may form a close interface between an electrode layer and a solid electrolyte layer. An all-solid-state rechargeable battery including this can have improved battery performances such as rate capability, coulombic efficiency, and cycle-life characteristics.

The argyrodite-type sulfide-based solid electrolyte may be prepared, for example by mixing lithium sulfide and phosphorus sulfide, and optionally lithium halide. Heat treatment may be performed after mixing them. The heat treatment may include, for example, two or more heat treatment steps. Here, the preparing of the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

The first solid electrolyte and the second solid electrolyte may be, as another example, an oxide-based inorganic solid electrolyte. The oxide-based inorganic solid electrolyte may include, for example, Li₁₊ₓTi₂₋ₓAl (PO₄)₃(LTAP) (O≤x≤4), Li_{1+x+y}AlₓTi₂₋ₓSi_{y}P_{3-y}O₁₂ (0<x<2, 0≤y<3), BaTiO₃, Pb (Zr,Ti)O₃(PZT), Pb₁₋ₓ LaₓZr_{1-y}Ti_{y}O₃(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y} Al, Ga) x (Ti, Ge)₂₋ₓSi_{y}P_{3-y}O₁₂(0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂—based ceramics, Garnet-based ceramics Li₃₊ₓLa₃M₂O₁₂ (wherein M=Te, Nb, or Zr; x is an integer of 1 to 10), or a mixture thereof.

The first solid electrolyte and the second solid electrolyte may each be in the form of particles, and the average particle diameter (D50) of the particles may be less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. The first solid electrolyte and the second solid electrolyte may be small particles having a size of 0.1 μm to 1.9 μm, large particles having a size of 2.0 μm to 5.0 μm, or a mixture thereof. The average particle diameter of the sulfide-based solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

Meanwhile, the average particle diameter (D50) of each of the first solid electrolyte and the second solid electrolyte included in the solid electrolyte layer may be larger than the average particle diameter (D50) of the solid electrolyte included in the positive electrode 200. In this case, the energy density of the all-solid-state rechargeable battery may be maximized while increasing the mobility of lithium ions to improve the overall performance. For example, the average particle diameter (D50) of the solid electrolyte included in the positive electrode 200 may be 0.1 μm to 1.9 μm, or 0.1 μm to 1.0 μm, and the average particle diameter (D50) of the solid electrolyte included in the solid electrolyte layer 300 may be 2.0 μm to 5.0 μm, or 2.0 μm to 4.0 μm, or 2.5 μm to 3.5 μm. When this particle size range is satisfied, the energy density of the all-solid-state rechargeable battery may be maximized while the transfer of lithium ions is facilitated, thereby suppressing resistance and improving the overall performance of the all-solid-state rechargeable battery.

Meanwhile, each of the first solid electrolyte layer and the second solid electrolyte layer may further include an alkali metal salt, and/or an ionic liquid, and/or a conductive polymer.

The alkali metal salt may be for example a lithium salt. A content of lithium salt in the solid electrolyte layer may be greater than or equal to 1 M or for example 1 M to 4 M. In this case, the lithium salt may improve ionic conductivity by improving lithium ion mobility in the solid electrolyte layer.

The lithium salt may include, for example, LiSCN, LIN(CN)₂, Li(CF₃SO₂)₃C, LiC₄F₉SO₃, LIN(SO₂CF₂CF₃)₂, LiCl, LIF, LiBr, Lil, LiB(C₂O₄)₂, LiBF₄, LIBF₃(C₂F₅), lithium bis(oxalato) borate (LiBOB), lithium oxalyldifluoroborate (LIODFB), lithium difluoro (oxalato) borate (LiDFOB), lithium bis(trifluoro methanesulfonyl) imide (LiTFSI, LIN(SO₂CF3)₂), lithium bis(fluorosulfonyl) imide (LIFSI, LIN (SO₂F)₂), LiCF₃SO₃, LiAsF₆, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LIN (SO₂CF3)₂), lithium bis(fluorosulfonyl) imide (LIFSI, LIN (SO₂F)₂). The lithium salt may maintain or improve ionic conductivity by appropriately maintaining chemical reactivity with the ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)2N—, (C₂F₅SO₂) (CF₃SO₂)N—, and (CF₃SO₂)2N—.

The ionic liquid may be, for example, one or more selected from N-methyl-N-propylpyrrolidinium bis(trifluoromethanesulfonyl) imide N-butyl-N-methylpyrrolidium bis(3-trifluoromethylsulfonyl)imide, 1-butyl-3-methylimidazolium bis(trifluoromethylsulfonyl) amide, and 1-ethyl-3-methylimidazolium bis(trifluoromethylsulfonyl) amide.

A weight ratio of the solid electrolyte and the ionic liquid in the solid electrolyte layer may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

### Negative Electrode

A negative electrode for an all-solid-state rechargeable battery includes a current collector and a negative electrode active material layer on the current collector. The negative electrode active material layer may include a negative electrode active material, may further include binder and/or conductive material.

In this case, the aforementioned first solid electrolyte layer may be a surface in contact with the negative electrode active material layer.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sₙ.

The material capable of doping/dedoping lithium may be a Si-based negative electrode active material or a Sₙ—based negative electrode active material. The Si-based negative electrode active material may include silicon, a silicon-carbon composite, SiOₓ (0<x<2), a Si—Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sₙ—based negative electrode active material may include Sₙ, SnO₂, a Sₙ—R alloy (wherein R is an alkali metal, an alkaline-earth metal, a Group 13 element, a Group 14 element, a Group 15 element, a Group 16 element, a transition metal, a rare earth element, and a combination thereof, but not Sₙ). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Here, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sₙ—based negative electrode active material may be used by mixing with a carbon-based negative electrode active material. When using a mixture of Si-based negative electrode active material or Sₙ—based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

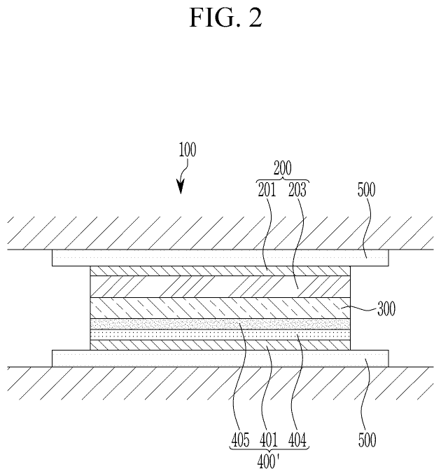

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

In this case, the first solid electrolyte layer may be referred to as a surface in contact with the negative electrode coating layer 405.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Here, the precipitation of the lithium metal may be effectively promoted and improve characteristics of the all-solid-state battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like. The thin film may have, for example, a thickness of 1 nm to 500 nm.

The lithium metal layer 404 may include lithium metal or lithium alloy. For example, the lithium alloy may be Li—Al alloy, Li—Sₙ alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Positive Electrode

In an embodiment, the positive electrode includes a current collector and a positive electrode active material layer on the current collector, wherein the positive electrode active material layer includes a positive electrode active material and a solid electrolyte, and optionally a binder and/or a conductive material.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

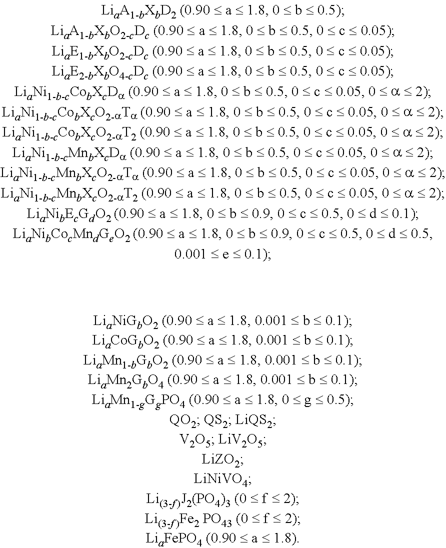

In the chemical formulas, A is selected from Ni, Co, Mn, and a combination thereof; X is selected from AI, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from AI, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

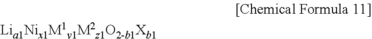

In Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from AI, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 11, 0.6≤x1≤1, 0syl≤0.4, and 0≤z1≤0.4 or 0.8≤x1≤1, 0≤y1≤0.2, and 0≤z1≤0.2.

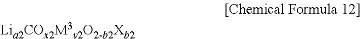

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

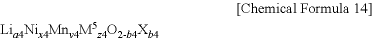

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

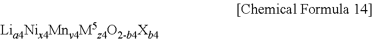

In Chemical Formula 14, 0.9≤a2≤1.8, 0.8≤x4<1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Here, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Solid Electrolyte

The solid electrolyte included in the positive electrode active material layer may include a sulfide-based solid electrolyte, an oxide-based solid electrolyte, or a combination thereof, and may be, for example, an argyrodite-type sulfide-based solid electrolyte. Because the solid electrolyte has been described above, detailed descriptions therefor is omitted.

The solid electrolyte may be included in an amount of 0.1 wt % to 35 wt %, for example 1 wt % to 35 wt %, 5 wt % to 30 wt %, 8 wt % to 25 wt %, or 10 wt % to 20 wt % based on 100 wt % of the positive electrode active material layer.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

### Binder

The binder serves to adhere the positive electrode active material particles to each other and also to properly attach the positive electrode active material to the current collector. Examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto.

A content of the binder may be approximately 0.1 wt % to 5 wt % based on 100 wt % of the positive electrode active material layer in the positive electrode active material layer.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The positive electrode current collector may include an aluminum foil, but is not limited thereto.

Method of Manufacturing All-solid-state Rechargeable Battery

In an embodiment, a method for manufacturing the aforementioned all-solid-state rechargeable battery is provided. The method of manufacturing an all-solid-state rechargeable battery includes (i) preparing a negative electrode, (ii) coating a first composition including a first solid electrolyte and a first binder on the negative electrode to form a first solid electrolyte layer, (iii) coating a second composition including a second solid electrolyte and a second binder on a first solid electrolyte layer to form a second solid electrolyte layer, and then drying it, and (iv) stacking a positive electrode on the second solid electrolyte layer. Here, a glass transition temperature of the first binder is characterized to be higher than that of the second binder. The manufacturing method belongs to a multi-layered continuous coating method and is excellent in processability and economical.

Here, the contents of the negative electrode, the first solid electrolyte, the first binder, the first solid electrolyte layer, the second solid electrolyte, the second binder, the second solid electrolyte layer, and the positive electrode are the same as described above.

The preparing the negative electrode may be, for example, performed by forming a negative electrode coating layer including lithiophilic metal, a carbon material, or a combination thereof on a negative electrode current collector to prepare a precipitation-type negative electrode including the current collector and the negative electrode coating layer. Here, the first composition may be applied on the negative electrode coating layer. In addition, the method of manufacturing an all-solid-state rechargeable battery may further include pressing the negative electrode before coating the first composition on the negative electrode.

The first composition may further include a first solvent in addition to the first solid electrolyte ad the first binder, and the second composition also may further include a second solvent in addition to the second solid electrolyte and the second binder. For example, the first solvent and the second solvent independently may include isobutyryl isobutyrate, xylene, toluene, benzene, hexane, alkyl acetate, alkyl propionate, or a combination thereof.

The coating the first and second compositions may be performed in various methods, for example, blade coating, bar coating, die casting coating, comma coating, etc.

After applying the second composition on the first solid electrolyte layer to form the second solid electrolyte layer, a drying process may be performed, for example, at 60° C. to 200° C. under a normal pressure or vacuum for 0.5 hour to 20 hours.

Through the drying process, the first binder and the second binder may partially move, diffuse, or migrate in the solid electrolyte layer, thereby forming the third solid electrolyte layer, in which the first binder and the second binder are mixed, between the first solid electrolyte layer and the second solid electrolyte layer. Furthermore, the first binder in the solid electrolyte layer may exhibit a concentration gradient of decreasing from the negative electrode toward the positive electrode, and the second binder may exhibit a concentration gradient of decreasing from the positive electrode toward the negative electrode.

The stacking the positive electrode on the second solid electrolyte layer may be stacking them so that the positive electrode active material layer may contact with the second solid electrolyte layer.

The method of manufacturing an all-solid-state rechargeable battery may further include a battery structure that after stacking the positive electrode, the negative electrode, the first solid electrolyte layer, the second solid electrolyte layer, and the positive electrode in order are staked thereon.

An all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

Hereinafter, examples and comparative examples of the present invention will be described. The following examples are only examples of the present invention and the present invention is not limited to the following examples.

### Example 1

### 1. Manufacturing of Negative Electrode

An Ag/C composite is prepared by mixing carbon black having a primary particle diameter (D50) of about 30 nm and silver (Ag) having an average particle diameter (D50) of about 60 nm in a weight ratio of 3:1, and 0.25 g of the composite is added to 2 g of an NMP solution including 7 wt % of a polyvinylidene fluoride binder to prepare a negative electrode coating layer composition. The negative electrode coating layer composition is bar-coated on an SUS current collector and then, vacuum-dried and pressed to prepare a precipitation-type negative electrode having a negative electrode coating layer on the current collector.

2. Formation of First Solid Electrolyte Layer A first composition is prepared by dissolving an acrylic binder (Zeon, A681) with a glass transition temperature of about 20° C. as a first binder in octyl acetate (OA) as a solvent to prepare a binder solution, adding an argyrodite-type solid electrolyte (Li₃PS₅Cl) with an average particle diameter (D50) of about 3 μm and a dispersant thereto, and stirring the mixture. In the first composition, 98 wt % of the solid electrolyte, 1.3 wt % of the binder, and 0.7 wt % of the dispersant are included. The first composition is coated at 5 mm/son the negative electrode coating layer of the negative elect by using a blade coater to form a first solid electrolyte layer.

### 3. Formation of Second Solid Electrolyte Layer

A second composition is prepared by dissolving a hydrogenated nitrile butadiene rubber binder (THERBAN® LT1707) with a glass transition temperature of about −40° C. as a second binder in an OA solvent to prepare a binder solution, adding an argyrodite-type solid electrolyte (Li₃PS₅Cl) with an average particle diameter (D50) of about 3 μm and a dispersant thereto, and stirring the mixture. In the second composition, 98.5 wt % of the solid electrolyte, 1.3 wt % of the binder, and 0.7 wt % of the dispersant are included. The second composition is coated at 5 mm/s on the first solid electrolyte layer with a blade coater to form a second solid electrolyte layer, which is dried at about 130° C. for 10 minutes to 30 minutes and then, dried again under vacuum about 80° C. for 2 hours to 4 hours.

### 4. Manufacturing of Positive Electrode

A positive electrode composition is prepared by mixing 85 wt % of a positive electrode active material of LiNi_{0.9}Co_{0.05}Mn_{0.05}O₂ coated with Li₂O—ZrO₂, 13.5 wt % of an argyrodite-type solid electrolyte (Li₆PS₅Cl), 1.0 wt % of a PVdF binder, and 0.5 wt % of a carbon nanotube conductive material in an OA solvent. The prepared positive electrode composition is bar-coated on a positive electrode current collector and then, vacuum-dried to manufacture a positive electrode having a positive electrode active material layer formed on the current collector.

5. Manufacturing of All-solid-state Rechargeable Battery Cell

The positive electrode is stacked on the second solid electrolyte layer so that the positive electrode active material layer of the positive electrode may come into contact with the second solid electrolyte layer. The negative electrode, the first solid electrolyte layer, the second solid electrolyte layer, and the positive electrode are sequentially stacked into an assembly, which is inserted into a pouch, sealed, and subjected to warm isostatic press (WIP) with 500 Mpa for 30 minutes at a high temperature of 85° C. to manufacture an all-solid-state rechargeable battery cell.

In the all-solid-state rechargeable battery, the first solid electrolyte layer and the second solid electrolyte layer respectively have a thickness of about 50 μm, wherein a third solid electrolyte layer, in which the first binder and the second binder are mixed, is formed between the first solid electrolyte layer and the second solid electrolyte layer. In the entire solid electrolyte layer, the first binder exhibits a concentration gradient with its content decreasing from the negative electrode toward the positive electrode, but the second binder exhibits a concentration gradient with its content decreasing from the positive electrode toward the negative electrode.

### Comparative Example 1

A solid electrolyte layer composition is prepared by dissolving a hydrogenated nitrile butadiene rubber binder with a glass transition temperature of about −40° C. (LT1707, THERBAN®) in an OA solvent to prepare a binder solution, adding an argyrodite-type solid electrolyte (Li₆PS₅Cl) with an average particle diameter (D50) of about 3 μm and a dispersant thereto, and stirring the mixture. This solid electrolyte layer composition is coated on a negative electrode to form a monolayer of a solid electrolyte layer. Except for this, a negative electrode, a positive electrode, and an all-solid-state rechargeable battery cell are manufactured substantially in the same manner as in Example 1.

### Comparative Example 2

A solid electrolyte layer composition is prepared by dissolving an acrylic rubber binder (A681, Zeon) with a glass transition temperature of about 20° C. (THERBAN® LT1707) in an OA solvent to prepare a binder solution, adding an argyrodite-type solid electrolyte (Li₃PS₅Cl) with an average particle diameter (D50) of about 3 μm and a dispersant thereto, and stirring the mixture.

This solid electrolyte layer composition is coated on a negative electrode to form a monolayer of a solid electrolyte layer. Except for this, a negative electrode, a positive electrode, and an all-solid-state rechargeable battery cell are manufactured substantially in the same manner as in Example 1.

### Comparative Example 3

An all-solid-state rechargeable battery cell is manufactured substantially the same manner as in Example 1 except that the second solid electrolyte layer on the negative electrode, and the first solid electrolyte layer is formed on the second solid electrolyte layer by alternating the order of forming the solid electrolyte layers.

### Evaluation Example 1: Initial Charge/Discharge Capacity Evaluation

The all-solid-state rechargeable battery cells according to Example 1 and Comparative Examples 1 to 3 are charged to an upper limit voltage of 4.25 V at a constant current of 0.1 C and discharged to a cut-off voltage of 2.5 V at 0.1 C at 45° C. for initial charge and discharge. Table 1 below shows initial charge, initial discharge, and a ratio of discharge to charge as efficiency.

TABLE 1

| | Charge | Discharge | Efficiency |
|---|---|---|---|
| | (mAh/g) | (mAh/g) | (%) |
| Comparative Example 1 | 229.20 | 209.46 | 91.39 |
| Comparative Example 2 | 229.61 | 211.54 | 92.13 |
| Comparative Example 3 | 231.85 | 213.89 | 92.25 |
| Example 1 | 232.37 | 214.19 | 92.18 |

Referring to Table 1, Example 1, compared with Comparative Examples 1 to 3, is confirmed to exhibit an increase in initial charge and discharge capacity and maintain excellent initial charge and discharge efficiency.

### Evaluation Example 2: Rate Capability Evaluation

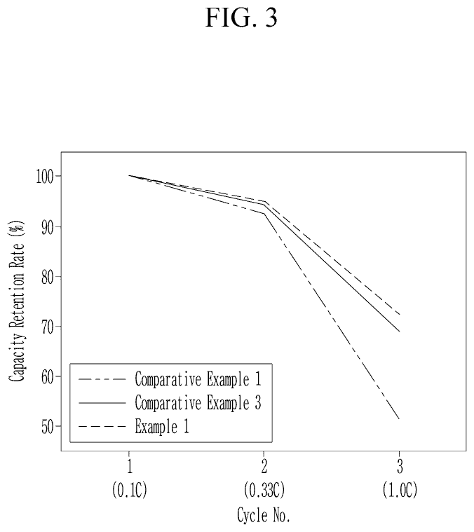

The all-solid-state rechargeable battery cells of Example 1 and Comparative Examples 1 to 3 are charged to an upper limit voltage of 4.25 V at a constant current of 0.1 C and discharged to a cut-off voltage of 2.5 V at 0.1 C at 45° C. for first charge and discharge. Subsequently, the cells are charged at 0.1 C and discharge at 0.33 C within the same voltage range as a second cycle. Then, the cells are charged at 0.1 C and discharge at 1.0 C within the same voltage range as a third cycle. A ratio of discharge capacity at each cycle to discharge capacity at the first cycle is calculated and then, shown as capacity retention in FIG. 3. Referring to FIG. 3, while Comparative Examples 1 and 3 exhibit insufficient rate capability due to overcharge at high rates, Example 1 realizes excellent rate capability.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery 200: positive electrode
201: positive electrode current collector
203: positive electrode active material layer
300: solid electrolyte layer 400: negative electrode
401: negative electrode current collector
403: negative electrode active material layer
400′: precipitation-type negative electrode 404: lithium metal layer
405: negative electrode coating layer 500: elastic layer

1. An all-solid-state rechargeable battery, comprising a negative electrode, a positive electrode, and a solid electrolyte layer between the negative electrode and positive electrode,
wherein the solid electrolyte layer comprises a first solid electrolyte layer in contact with the negative electrode, and a second solid electrolyte layer in contact with the positive electrode,
the first solid electrolyte layer includes a first solid electrolyte and a first binder, the second solid electrolyte layer includes a second solid electrolyte and a second binder, and
a glass transition temperature of the first binder is higher than a glass transition temperature of the second binder.

2. The all-solid-state rechargeable battery as claimed in claim 1, wherein
the glass transition temperature of the first binder is 0.1° C. to 350° C. higher than the glass transition temperature of the second binder.

3. The all-solid-state rechargeable battery as claimed in claim 1, wherein
the glass transition temperature of the first binder is 5° C. to 200° C., and
the glass transition temperature of the second binder is −150° C. to 5° C.

4. The all-solid-state rechargeable battery as claimed in claim 1, wherein
the first binder and the second binder are each independently selected from a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a chloroprene rubber, a natural rubber, polydimethylsiloxane, polyethylene oxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoropropylene copolymer, polyvinyl chloride, carboxylated polyvinyl chloride, polyvinyl fluoride, polyethylene, polypropylene, ethylene propylene copolymer, ethylene propylene diene copolymer, polyamideimide, polyimide, poly(meth)acrylate, polyalkyl (meth)acrylate, polyacrylonitrile, polystyrene, polyurethane, or a combination thereof.

5. The all-solid-state rechargeable battery as claimed in claim 1, wherein
the first binder comprises polystyrene, polyurethane, polyimide, polyamideimide, poly(meth)acrylate, polyalkyl (meth)acrylate, polyacrylonitrile, or a combination thereof, and
the second binder comprises an acrylic rubber, an acrylonitrile-butadiene rubber, a nitrile-butadiene rubber, a hydrogenated nitrile-butadiene rubber, a styrene-butadiene rubber, a butyl rubber, a fluorine rubber, a chloroprene rubber, a natural rubber, polydimethylsiloxane, or a combination thereof.

6. The all-solid-state rechargeable battery as claimed in claim 1, wherein
the first binder is included in an amount of 0.1 wt % to 5 wt % based on 100 wt % of the first solid electrolyte layer, and
the second binder is included in an amount of 0.1 wt % to 5 wt % based on 100 wt % of the second solid electrolyte layer.

7. The all-solid-state rechargeable battery as claimed in claim 1, wherein
a content of the first binder based on 100 wt % of the first solid electrolyte layer is greater than a content of the second binder with respect to 100 wt % of the second solid electrolyte layer,
the first binder is included in an amount of 1.5 wt % to 5 wt % based on 100 wt % of the first solid electrolyte layer, and
the second binder is included in an amount of 0.1 wt % to 1.0 wt % based on 100 wt % of the second solid electrolyte layer.

8. The all-solid-state rechargeable battery as claimed in claim 1, wherein
a thickness of the first solid electrolyte layer is 10 μm to 200 μm, and
a thickness of the second solid electrolyte layer is 10 μm to 200 μm.

9. The all-solid-state rechargeable battery as claimed in claim 1, wherein
the solid electrolyte layer further includes a third solid electrolyte layer between the first solid electrolyte layer and the second solid electrolyte layer, and in the third solid electrolyte layer, the first solid electrolyte, the second solid electrolyte, the first binder, and the second binder are mixed therein.

10. The all-solid-state rechargeable battery as claimed in claim 1, wherein
the first binder within the solid electrolyte layer has a concentration gradient in which the content thereof decreases from the negative electrode side to the positive electrode side, and the second binder has a concentration gradient in which the content the content thereof decreases from the positive electrode side to the negative electrode side.

11. The all-solid-state rechargeable battery as claimed in claim 1, wherein the first solid electrolyte and the second solid electrolyte are a sulfide-based solid electrolyte, and
the sulfide-based solid electrolyte comprises argyrodite-type sulfide, and/or
the first solid electrolyte is in a form of particles, and an average particle diameter (D50) of the particles is 0.1 μm to 5.0 μm, and
the second solid electrolyte is in a form of particles and the average particle diameter (D50) of the particles is 0.1 μm to 5.0 μm.

12. (canceled)

13. (canceled)

14. The all-solid-state rechargeable battery as claimed in claim 1, wherein the negative electrode comprises a current collector and a negative electrode coating layer disposed on the current collector and including a lithiophilic metal, a carbon material, or a combination thereof, and
a lithium metal layer formed by charging between the current collector and the negative electrode coating layer, and
the positive electrode comprises a current collector and a positive electrode active material layer located on the current collector and including a positive electrode active material, and
the positive electrode active material comprises lithium cobalt oxide, lithium nickel oxide, lithium nickel cobalt oxide, lithium nickel cobalt aluminum oxide, lithium nickel cobalt manganese oxide, lithium nickel manganese oxide, lithium manganese oxide, lithium iron phosphate, or a combination thereof.

15. (canceled)

16. The all-solid-state rechargeable battery as claimed in claim 1, wherein
the positive electrode comprises a current collector and a positive electrode active material layer located on the current collector and including a positive electrode active material,
the positive electrode active material comprises a lithium nickel-based oxide represented by Chemical Formula 11: 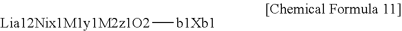
wherein, in Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

17. The all-solid-state rechargeable battery as claimed in claim 1, wherein
the positive electrode comprises a current collector and a positive electrode active material layer on the current collector,
the positive electrode active material layer comprises a positive electrode active material and a sulfide-based solid electrolyte, and
65 wt % to 99 wt % of the positive electrode active material and 1 wt % to 35 wt % of solid electrolyte are included based on 100 wt % of the positive electrode active material and the solid electrolyte.

18. A method of manufacturing an all-solid-state rechargeable battery, comprising
preparing a negative electrode,
coating a first composition including a first solid electrolyte and a first binder on the negative electrode to form a first solid electrolyte layer,
coating a second composition including a second solid electrolyte and a second binder on a first solid electrolyte layer to form a second solid electrolyte layer, and then drying it, and
stacking a positive electrode on the second solid electrolyte layer,
wherein a glass transition temperature of the first binder is higher than a glass transition temperature of the second binder.

19. The method as claimed in claim 18, wherein
the glass transition temperature of the first binder is 0.1° C. to 350° C. higher than the glass transition temperature of the second binder, or
the glass transition temperature of the first binder is 5° C. to 200° C., and
the glass transition temperature of the second binder is −150° C. to 5° C.

20. (canceled)

21. The method as claimed in claim 18, wherein
the first binder comprises polystyrene, polyurethane, polyimide, polyamideimide, poly(meth)acrylate, polyalkyl (meth)acrylate, polyacrylonitrile, or a combination thereof, and
the second binder comprises an acrylic rubber, an acrylonitrile-butadiene rubber, a nitrile-butadiene rubber, a hydrogenated nitrile-butadiene rubber, a styrene-butadiene rubber, a butyl rubber, a fluorine rubber, a chloroprene rubber, a natural rubber, polydimethylsiloxane, or a combination thereof.

22. The method as claimed in claim 18, wherein
the first binder is included in an amount of 0.1 wt % to 5 wt % based on 100 wt % of the first composition, and
the second binder is included in an amount of 0.1 to 5 wt % based on 100 wt % of the second composition, and/or
the first solid electrolyte and the second solid electrolyte are argyrodite-type sulfide-based solid electrolytes, are in the form of particles, and the average particle diameter (D50) of the particles is 0.1 μm to 5.0 μm.

23. (canceled)

24. The method as claimed in claim 18, wherein
the drying after forming a second solid electrolyte layer is performed at a temperature range of 60° C. to 200° C. under normal pressure or vacuum conditions for 0.5 to 20 hours, and/or
a portion of the first binder and the second binder is moved by the drying process after forming the second solid electrolyte layer, and a third solid electrolyte layer in which the first binder and the second binder are mixed is formed between the first solid electrolyte layer and the second solid electrolyte layer, and/or
the first binder exhibits a concentration gradient in which a content thereof decreases from the negative electrode side to the positive electrode side, and the second binder exhibits a concentration gradient in which a content thereof decreases from the positive electrode side to the negative electrode side.

25. (canceled)

26. The method as claimed in claim 18, wherein
the negative electrode comprises a current collector and a negative electrode coating layer located on the current collector and including a lithiophilic metal, a carbon material, or a combination thereof, and
a lithium metal layer is formed by charging between the current collector and the negative electrode coating layer.
